(19) United States
(12) Patent Application Publication
(10) Pub. No.: US 2016/0246099 A1
(43) Pub. Date: Aug. 25, 2016

(54) LIQUID CRYSTAL DISPLAY DEVICE

(71) Applicant: Shenzhen China Star Optoelectronics Technology Co., Ltd., Shenzhen, Guangdong (CN)

(72) Inventor: Yuejun Tang, Shenzhen, Guangdong (CN)

(73) Assignee: Shenzhen China Star Optoelectronics Technology Co., Ltd., Shenzhen, Guangdong (CN)

(21) Appl. No.: 14/417,716

(22) PCT Filed: Jan. 13, 2015
(86) PCT No.: PCT/CN2015/070588

§ 371 Date: May 6, 2016

(30) Foreign Application Priority Data
Dec. 19, 2014 (CN) 201410804223.3

(51) Int. Cl. G02F 1/1339; G02F 1/1362; G02F 1/1335

(52) U.S. Cl. CPC G02F 1/13394; G02F 1/133514; G02F 1/136286; G02F 2001/13398; G02F 2001/13396

(57) ABSTRACT

Disclosed is a liquid crystal display device, comprising a first substrate, a second substrate arranged opposite to the first substrate in a second state, a plurality of first protrusions arranged on the second substrate, and a plurality of second protrusions. Each of the plurality of first protrusions has a first lower portion which is made of a rigid material and arranged adjacent to a fixed end thereof, and a first upper portion which is made of an elastic material and arranged away from the fixed end thereof, wherein the plurality of first protrusions is pressed in the second state. The plurality of second protrusions is arranged on the second substrate and/or the first substrate. Each of the plurality of second protrusions has a second upper portion which is made of an elastic material and arranged away from a fixed end thereof, and a second lower portion which is made of a rigid material and arranged adjacent to the fixed end thereof, wherein in the second state, an interval is formed between a surface of the second upper portion and an inner surface of the first substrate or the second substrate opposite thereto. The liquid crystal display device has superior dynamic pressure resistance ability and a large allowable range for filling amount of liquid crystals.

### CROSS-REFERENCE TO RELATED APPLICATIONS

The present application claims benefit of Chinese patent application CN 201410804223.3, entitled “Liquid crystal display device” and filed on Dec. 19, 2014, the entirety of which is incorporated herein by reference.

### FIELD OF THE INVENTION

The present disclosure relates to a display device, and in particular, to a liquid crystal display device.

### BACKGROUND OF THE INVENTION

With rapid development of the photoelectric technology develops, liquid crystal displays having the features of small sizes, light weight, superior display effects, and the like are increasingly popular among consumers.

FIG. 1 shows a perspective view of a liquid crystal display in the prior art. As indicated in FIG. 1, a liquid crystal display 100 comprises a lower substrate 80, an upper substrate 90, and a liquid crystal layer 99 arranged between the upper substrate 90 and the lower substrate 80. The lower substrate 80 comprises a plurality of scan lines 81, a plurality of data lines 82, a plurality of pixel electrodes 83, and a plurality of thin film transistors 84. The plurality of scan lines 81 is arranged on an inner surface (which faces the upper substrate 90) of the lower substrate 80 at intervals along a first direction. Similarly, the plurality of data lines 82 is arranged on the inner surface of the lower substrate 80 at intervals along a second direction, which is perpendicular to the first direction. The plurality of pixel electrodes 83 is respectively arranged in a plurality of pixel regions P defined by the plurality of scan lines 81 and the plurality of data lines 82. The upper substrate 90 comprises a black bottom layer 91, a color filter layer 92, and a common electrode 93.

In addition, as shown in FIG. 2, the upper substrate 90 is provided with a plurality of spacers 94 thereon, while the lower substrate 80 is provided with a plurality of protrusions 85 thereon. Each of the plurality of protrusions 85 is connected to a spacer s 94 of the upper substrate 90. Such a design enables a favorable interval to be formed between the upper substrate 90 and the lower substrate 80.

However, the liquid crystal display 100 of such a structure also has certain defects. For instance, because the spacers 94 and the protrusions 85 can provide poor bearing forces merely, the panel of the liquid crystal display might fail due to gravity thereof or external pressures, thereby deteriorating display effects of the liquid crystal display 100.

To conclude the above, it is necessary to design a liquid crystal display device with enhanced display effects.

### SUMMARY OF THE INVENTION

Directed against the above technical problem existing in the prior art, the present disclosure provides a liquid crystal display device, which can improve dynamic pressure resistance ability of a panel, and meanwhile enlarge an allowable range for filling amount of liquid crystals into the liquid crystal display device, thereby ensuring display effects of the liquid crystal display device.

According to the present disclosure, a liquid crystal display device is provided, comprising: a first substrate; a second substrate, arranged opposite to the first substrate in a second state; a plurality of first protrusions arranged on the second substrate, each of the plurality of first protrusions having a first lower portion which is made of a rigid material and arranged adjacent to a fixed end thereof, and a first upper portion which is made of an elastic material and arranged away from the fixed end thereof, wherein the plurality of first protrusions is pressed in the second state; and a plurality of second protrusions arranged on the second substrate and/or the first substrate, each of the plurality of second protrusions having a second lower portion which is made of a rigid material and arranged adjacent to a fixed end thereof, and a second upper portion which is made of an elastic material and arranged away from the fixed end thereof, wherein in the second state, an interval is formed between a surface of the second upper portion and an inner surface of the first substrate or the second substrate opposite thereto.

According to the liquid crystal display device of the present disclosure, when the first substrate and the second substrate are assembled to form the panel, i.e., in the second state, the first upper portion of the first protrusion will be considerably deformed in an elastic manner under pressure, with a large elastic recovery rate, which is beneficial for enlarging the allowable range for filling amount of liquid crystals into the liquid crystal display device, and meanwhile preventing the problem of an undesirable vertical flow of gravity. As a result, the liquid crystal display will have a larger application range, with improved display quality. Moreover, in the second state, since the interval is formed between the surface of the second upper portion and the inner surface of either the first substrate or the second substrate opposite thereto, the panel will gain a significantly compressible amount, which can vary with the amount of liquid crystals within a large scope. This can prevent occurrence of bubbles in the liquid crystal display device. While the panel is under dynamic pressure or compression, the plurality of first protrusions and the plurality of second protrusions are both compressed to bear the pressure together, thereby improving the dynamic pressure resistance ability of the panel. Meanwhile, because the first upper portion and the second upper portion are largely deformed, the rigid material of the first lower portion and the second lower portion can function to bear external pressures. Thus, the liquid crystal display panel with such a structure can achieve a satisfactory balance between the allowable range for filling amount of liquid crystals and the dynamic pressure resistance ability of the panel, thereby ensuring display quality of the liquid crystal display device. In addition, if the first upper portion or the second upper portion is in contact with a PI alignment film of a substrate opposite thereto, abrasion at a contact area between the first upper portion or the second upper portion and the substrate opposite thereto can be relieved since the first upper portion and the second upper portion are both made of an elastic material, thereby preventing the PI alignment film from being scratched. The display quality of the liquid crystal display device can thus be ensured.

In one embodiment, the interval ranges from 0.01 to 0.2 μm. Such a range enables a larger allowable range for filling amount of liquid crystals while improving the dynamic pressure resistance ability of the liquid crystal display device.

In one specific embodiment, the plurality of first protrusions is homogeneously distributed on the second substrate, and/or in the second state, the plurality of second protrusions is located outside of the plurality of first protrusions and distributed around the plurality of first protrusions in a homogeneous manner. Such an arrangement enables certain properties such as homogeneous dynamic pressure resistance ability of the whole panel, thereby improving quality of the liquid crystal display device. Meanwhile, this structure can facilitate production and processing of the liquid crystal display device at reduced production costs.

In one specific embodiment, the plurality of second protrusions has a distribution density larger than the plurality of first protrusions. This arrangement can improve the dynamic pressure resistance ability of the panel while maintaining bearing forces between panels.

In one specific embodiment, in a first state, the plurality of first protrusions has an elevation larger than the plurality of the second protrusions, and/or the first lower portion and the second lower portion have a same elevation. Preferably, the elevation of the plurality of first protrusions is 0.3-0.7 μm larger than that of the plurality of second protrusions. Further preferably, the elevation of the plurality of first protrusions is 0.5 μm larger than that of the plurality of first protrusions. The first state herein refers to a state in which the first substrate and the second substrate are not assembled yet. At this moment, the plurality of first protrusions and the plurality of second protrusions at respective substrates are in a natural state without being pressed. Through such a structure, when the first substrate and the second substrate are assembled to form a panel, the panel per se would be under homogeneous pressure, which is favorable for improving the dynamic pressure resistance ability of the panel and the allowable range for filling amount of liquid crystals. Meanwhile, production and assembly can be facilitated. Particularly, when the elevation of the first lower portion and the second lower portion are the same with each other, production of the first lower portion and that of the second lower portion can be completed simultaneously, thereby simplifying production.

In another specific embodiment, in the first state, the plurality of first protrusions and the plurality of second protrusions have a same elevation, and the first substrate is provided with a plurality of abutment members thereon corresponding to the plurality of first protrusions. With such an arrangement, the plurality of first protrusions can be pressed in the second state, and the interval can be formed between the second protrusion and an opposite substrate thereof also. Similarly, display quality of the liquid crystal display device can be ensured.

In one specific embodiment, the first substrate is in the form of an array substrate, while the second substrate is in the form of a color filter substrate, and the plurality of first protrusions and the plurality of second protrusions are both arranged on a black bottom layer of the color filter substrate, and correspond to a plurality of scan lines of the array substrate. Such an arrangement enables a larger allowable range for filling amount of liquid crystals into the liquid crystal display device, and improves the dynamic pressure resistance ability of the liquid crystal display device, while facilitating production of the liquid crystal display.

In one specific embodiment, the elastic material is a hydrocarbon polymer, and/or the rigid material is silicon dioxide or a metal material. Preferably, the hydrocarbon polymer can be an aromatic polymer or an aliphatic resin polymer. The metal material can be aluminum, iron, etc.

In one specific embodiment, the first upper portion covers the first lower portion, and/or the second upper portion covers the second lower portion.

In one specific embodiment, the first upper portion and the first lower portion are both configured in the form of truncated cones or truncated ellipsoids, and/or the second upper portion and the second lower portion are both configured in the form of truncated cones or truncated ellipsoids.

Compared with the prior art, the present disclosure has the following advantages. The plurality of first protrusions and the plurality of second protrusions are arranged between the first substrate and the second substrate, wherein each of the plurality of first protrusions comprises the first upper portion and the first lower portion, while each of the plurality of the second protrusion comprises the second upper portion and the second lower portion. This enables the panel to easily return to its original position when an external force exerted thereon disappears. Meanwhile, the aforementioned arrangement improves the panel's dynamic pressure resistance ability and the allowable range for filling amount of liquid crystals, thereby enhancing display quality of the liquid crystal display device. In addition, the liquid crystal display of such a structure can be conveniently manufactured, which is beneficial for production thereof.

### BRIEF DESCRIPTION OF THE DRAWINGS

In the following, preferred embodiments of the present disclosure will be illustrated in detail in connection with accompanying drawings, in which:

FIG. 1 shows a perspective view of a liquid crystal display in the prior art;

FIG. 2 shows a cross-section view of a liquid crystal display in the prior art;

FIG. 3 shows a cross-section view of a liquid crystal display device according to one embodiment of the present disclosure;

FIG. 4 shows a cross-section view of a second substrate of a liquid crystal display device according to one embodiment of the present disclosure; and

FIG. 5 shows a cross-section view of a liquid crystal display device according to another embodiment of the present disclosure.

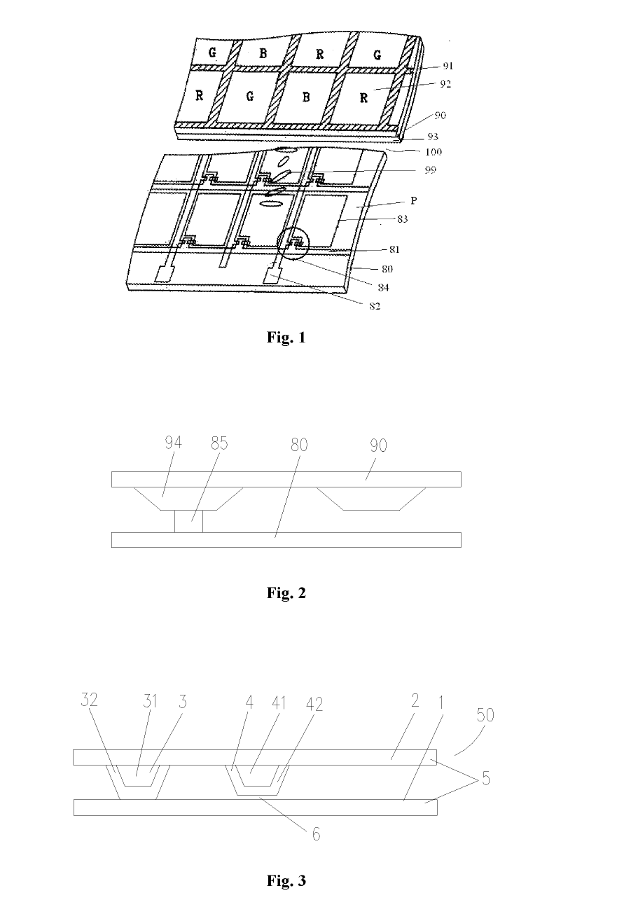

In the drawings, the same components are indicated with the same reference signs. The figures are not drawn in accordance with an actual scale.

### DETAILED DESCRIPTION OF THE EMBODIMENTS

The present disclosure will be further explained in conjunction with the accompanying drawings.

FIG. 3 schematically shows a cross-section view of a liquid crystal display device 50 according to one embodiment of the present disclosure. As indicated in FIG. 3, the liquid crystal display device 50 comprises a first substrate 1, a second substrate 2, a plurality of first protrusions 3, and a plurality of second protrusions 4. In a second state when the first substrate 1 and the second substrate 2 are assembled, the first substrate 1 and the second substrate 2 are arranged opposite to each other. In order to define a space between the first substrate 1 and the second substrate 2, the plurality of first protrusions 3 and the plurality of second protrusions 4 are located between the first substrate 1 and the second substrate 2. It should be understood that the liquid crystal display device 50 further comprises other components, which, along with assembling structures thereof, are well known by a skilled person in the art, and therefore will not be repeated herein for the sake of simplicity.

The plurality of first protrusions 3 is arranged on an inner surface of the second substrate 2, wherein the inner surface refers to a surface of the second substrate 2 facing the first substrate 1 when the first substrate 1 and the second substrate 2 are assembled with each other. And each of the plurality of first protrusions 3 has a first lower portion 31 adjacent to a fixed end thereof, and a first upper portion 32 away from the fixed end thereof The first upper portion 32 can be made of an elastic material, while the first lower portion 31 can be made of a rigid material. The plurality of second protrusions 4 can be arranged either on the second substrate 2 or on the first substrate 1, and surely can be arranged on both the first substrate 1 and the second substrate 2. Similarly, each of the plurality of second protrusions 4 has a second lower portion 41 adjacent to a fixed end thereof, and a second upper portion 42 away from the fixed end thereof The second upper portion 42 can be made of an elastic material, while the second lower portion 41 can be made of a rigid material. When the first substrate 1 and the second substrate 2 are assembled to form a panel 5, the plurality of first protrusions 3 is pressed, while an interval 6 is formed between each of the plurality of second protrusions 4 and an inner surface of an opposite substrate, i.e., either the first substrate 1 or the second substrate 2.

As such, when the panel 5 of the liquid crystal display device 50 is assembled, the first upper portion 32, due to the elastic material thereof, will be considerably deformed in an elastic manner, with a large elastic recovery rate, thereby enlarging an allowable range for filling amount of liquid crystals into the liquid crystal display device 50, and meanwhile preventing the problem of an undesirable vertical flow of gravity. Moreover, in the second state, since the interval 6 is formed between the end face of the second upper portion 42 and the inner surface of the opposite substrate, i.e., either the first substrate 1 or the second substrate 2, the panel 5 will gain a significantly compressible amount, which can vary with the amount of liquid crystals filled therein within a large scope. This can prevent occurrence of any bubble generated in the liquid crystal display device 50. At the same time, in the second state, while the panel 5 is under pressure, the first upper portion 32 will be in contact with a PI alignment film of the first substrate 1, and/or the second upper portion 42 will be in contact with a PI alignment film of a corresponding substrate. Since the elastic material is positioned in a contact region, the first upper portion 32, the second upper portion 42, and a surface of the PI alignment film can be all protected from being scratched. In addition, after the first substrate 1 and the second substrate 2 are assembled to form the panel 5, the plurality of first protrusions 3 and the plurality of second protrusions 4 will both be under pressure in dynamic pressure tests or repeated compression, thereby improving dynamic pressure resistance ability of the panel 5. Furthermore, due to large deformation of the first upper portion 32 and the second upper portion 42, the rigid material of the first lower portion 31 and that of the second lower portion 41 function as bearing external pressures. Thus, the liquid crystal display device 50 of such a structure secures both the allowable range for filling amount of liquid crystals of the panel 5, and the dynamic pressure resistance ability thereof, thereby ensuring display quality of the panel 5.

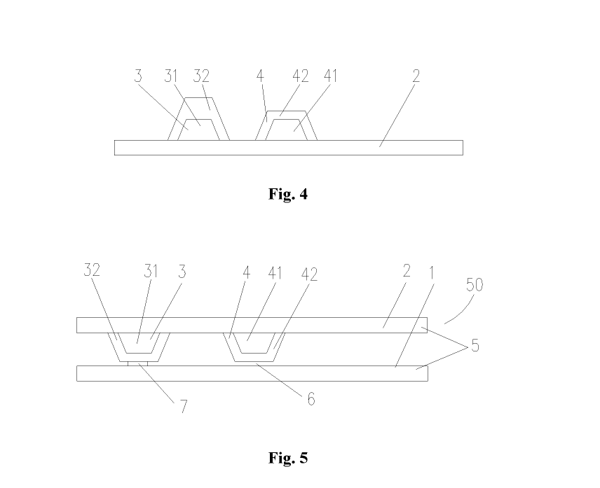

In one embodiment, in a first state, in which the first substrate 1 and the second substrate 2 are not assembled yet, the elevation of the plurality of second protrusions 4 is smaller than that of the plurality of first protrusions 3, as indicated in FIG. 4. Preferably, the elevation of the plurality of second protrusions 4 is 0.3-0.7 μm smaller than that of the plurality of first protrusions 3. Further preferably, the elevation of the plurality of second protrusions 4 is 0.5 μm smaller than that of the plurality of first protrusions 3. In a second state as shown in FIG. 3, in which the first substrate 1 is assembled with the second substrate 2, each of the plurality of first protrusions 3 is compressed under pressure, such that the first upper portion 32 is in contact with the inner surface of the first substrate 1. And the interval 6 is also formed between each of the plurality of second protrusions 4 and the inner surface of the opposite substrate thereof. Preferably, the interval 6 is in the range from 0.01 to 0.2 μm. Further preferably, the interval 6 is 0.1 μm. If each of the plurality of second protrusions 4 is also located on the second substrate 2, the interval 6 will then be formed between the second upper portion 42 and the inner surface of the first substrate 1.

In another embodiment, in the first state, the elevation of the plurality of second protrusions 4 is the same as that of the plurality of first protrusions 3, and the first substrate 1 is provided with an abutment member 7 thereon corresponding to each of the plurality of first protrusions 3. The abutment member 7 has an elevation preferably in the range from 0.3 to 0.7 μm, and can be, for instance, 0.5 μm. In the second state, in which the first substrate 1 and the second substrate 2 are assembled together, each of the plurality of first protrusions 3 is in contact with a corresponding abutment member 7 and thus compressed under pressure. And the interval 6 is also formed between each of the plurality of second protrusions 4 and the inner surface of the opposite substrate thereof. Similarly, the interval 6 as formed can be in the range from 0.01 to 0.2 μm. If each of the plurality of second protrusions 4 is also located on the second substrate 2, the interval 6 will then be formed between the second upper portion 42 and the inner surface of the first substrate 1.

It should be noted that in both of the above two embodiments, the plurality of second protrusions 4 is arranged on the second substrate 2, which only constitutes an example, but not to limit the present disclosure. That is, the plurality of second protrusions 4 can be arranged on the first substrate 1, or on the first substrate 1 and the second substrate 2 at the same time also.

It should be further noted that, in order to enable each of the plurality of first protrusions 3 to be pressed in the second state, the abutment member 7 can be in the form of a projection intentionally arranged on the first substrate 1 opposite thereto, or in the form of an existing structure that has already been arranged on the first substrate 1 opposite thereto. For example, if each of the plurality of first protrusions 3 is arranged on a color filter substrate, it can be arranged corresponding to a thin film transistor of an array substrate.

In order to ensure mechanical homogeneity of the liquid crystal display device 50 in a region of the entire panel 5, and improve display quality of the liquid crystal display device 50, the plurality of first protrusions 3 can be homogenously distributed on the second substrate 2. In the second state, the plurality of second protrusions 4 is located outside of the plurality of first protrusions 3, and is homogeneously distributed around the plurality of first protrusions 3.

In the region of the panel 5, the distribution density of the plurality of second protrusions 4 is larger than that of the plurality of first protrusions 3. For example, in the entire panel 5, the ratio of the number of the plurality of second protrusions 4 to the number of the plurality of first protrusions 3 is in the range from 20:1 to 50:1. When the panel 5 is pressed by a finger or other external forces, the plurality of second protrusions 4 and the plurality of first protrusions 3 cooperate with each other to resist deformation, thereby improving the dynamic pressure resistance ability of the panel 5.

In one specific embodiment, in the first state, the elevation of the first lower portion 32 is the same as that of the second lower portion 42. Hence, production of the first lower portion 32 and that of the second lower portion 42 can be completed simultaneously, thereby simplifying processing steps. It should be noted that the elevation of the first lower portion 32 can also be different from that of the second lower portion 42.

According to the present disclosure, in order to facilitate production and meanwhile ensure display quality of the liquid crystal display device 50, the plurality of second protrusions 4 and the plurality of first protrusions 3 can be preferably arranged on a same substrate, i.e., the second substrate 2. Further preferably, the first substrate 1 can be the lower substrate, i.e., the array substrate. The second substrate 2 is then the upper substrate, i.e., the color filter substrate. The present disclosure, however, is not limited to such an arrangement manner. That is, the first substrate 1 can be the upper substrate, and the second substrate 2 can be the lower substrate also.

In order to facilitate simple production steps and meanwhile ensure display quality of the liquid crystal display device 50, the plurality of first protrusions 3 and the plurality of second protrusions 4 can be both arranged on a black bottom layer (not shown in the drawings) of the color filter substrate 2, corresponding to a plurality of scan lines (not shown in the drawings) of the array substrate 1. It should be noted that, the plurality of first protrusions 3 and the plurality of second protrusions 4 are not limited to such an arrangement manner in position.

As shown in FIG. 4, the first upper portion 32 and the first lower portion 31 are both configured in the form of truncated cones or truncated ellipsoids, and the first upper portion 32 covers the first lower portion 31. The second upper portion 42 and the first lower portion 41 are both configured in the form of truncated cones or truncated ellipsoids, and the second upper portion 42 covers the second lower portion 41.

It should be noted that the first upper portion 32 and the first lower portion 31 can be configured in other forms, such as cylinders, cubes, and prismoids. Similarly, the second upper portion 42 and the second lower portion 41 can also be configured in other forms, such as cylinders, cubes, and prismoids.

It should be further noted that, the first upper portion 32 can cover, or half-cover the first lower portion 31, and alternatively the first upper portion 32 and the first lower portion 31 can be stacked or arranged in other positional relationships. Similarly, the second upper portion 42 can cover, or half-cover the second lower portion 41, and alternatively the second upper portion 42 and the second lower portion 41 can be stacked or arranged in other positional relationships.

In one specific embodiment, the elastic material can be a hydrocarbon polymer, and the rigid material can be silicon dioxide or a metal material. Preferably, the hydrocarbon polymer can be an aromatic polymer or an aliphatic resin polymer. The metal material can be aluminum, iron, copper, etc.

It should be noted that, in the present disclosure, the terms “upper” and “lower” only indicate relative positional relationships, instead of being a limitation to corresponding positions.

Although the present disclosure has been described with reference to preferred embodiments, various modifications and variants to the present disclosure may be made by anyone skilled in the art, without departing from the scope and spirit of the present disclosure. In particular, as long as there is no structural conflict, various embodiments as well as the respective technical features mentioned herein may be combined with one another in any manner. The present disclosure is not limited to the specific embodiments disclosed herein, but rather includes all the technical solutions falling within the scope of the claims.

1. A liquid crystal display device, comprising:
a first substrate,
a second substrate, arranged opposite to the first substrate in a second state,
a plurality of first protrusions arranged on the second substrate, each of the plurality of first protrusions having a first lower portion which is made of a rigid material and arranged adjacent to a fixed end thereof, and a first upper portion which is made of an elastic material and arranged away from the fixed end thereof, wherein the plurality of first protrusions is pressed in the second state, and
a plurality of second protrusions arranged on the second substrate and/or the first substrate, each of the plurality of second protrusions having a second lower portion which is made of a rigid material and arranged adjacent to a fixed end thereof, and a second upper portion which is made of an elastic material and arranged away from the fixed end thereof, wherein in the second state, an interval is formed between a surface of the second upper portion and an inner surface of the first substrate or the second substrate opposite thereto.

2. The liquid crystal display device according to claim 1, wherein the interval ranges from 0.01 to 0.2 μm.

3. The liquid crystal display device according to claim 1, wherein the plurality of first protrusions is homogeneously distributed on the second substrate, and/or
wherein in the second state, the plurality of second protrusions is located outside of the plurality of first protrusions, and distributed around the plurality of first protrusions in a homogeneous manner.

4. The liquid crystal display device according to claim 2, wherein the plurality of first protrusions is homogeneously distributed on the second substrate, and/or
wherein in the second state, the plurality of second protrusions is located outside of the plurality of first protrusions, and distributed around the plurality of first protrusions in a homogeneous manner.

5. The liquid crystal display device according to claim 3, wherein the plurality of second protrusions has a distribution density larger than the plurality of first protrusions.

6. The liquid crystal display device according to claim 4, wherein the plurality of second protrusions has a distribution density larger than the plurality of first protrusions.

7. The liquid crystal display device according to claim 1, wherein in a first state, the plurality of first protrusions has an elevation larger than the plurality of the second protrusions, and/or
wherein the first lower portion and the second lower portion have a same elevation.

8. The liquid crystal display device according to claim 2, wherein in a first state, the plurality of first protrusions has an elevation larger than the plurality of the second protrusions, and/or
wherein the first lower portion and the second lower portion have a same elevation.

9. The liquid crystal display device according to claim 3, wherein in a first state, the plurality of first protrusions has an elevation larger than the plurality of the second protrusions, and/or
wherein the first lower portion and the second lower portion have a same elevation.

10. The liquid crystal display device according to claim 4, wherein in a first state, the plurality of first protrusions has an elevation larger than the plurality of the second protrusions, and/or
wherein the first lower portion and the second lower portion have a same elevation.

11. The liquid crystal display device according to claim 1, wherein in a first state, the plurality of first protrusions and the plurality of second protrusions have a same elevation, and the first substrate is provided with a plurality of abutment members thereon corresponding to the plurality of first protrusions.

12. The liquid crystal display device according to claim 2, wherein in a first state, the plurality of first protrusions and the plurality of second protrusions have a same elevation, and the first substrate is provided with a plurality of abutment members thereon corresponding to the plurality of first protrusions.

13. The liquid crystal display device according to claim 3, wherein in a first state, the plurality of first protrusions and the plurality of second protrusions have a same elevation, and the first substrate is provided with a plurality of abutment members thereon corresponding to the plurality of first protrusions.

14. The liquid crystal display device according to claim 4, wherein in a first state, the plurality of first protrusions and the plurality of second protrusions have a same elevation, and the first substrate is provided with a plurality of abutment members thereon corresponding to the plurality of first protrusions.

15. The liquid crystal display device according to claim 1, wherein the first substrate is in the form of an array substrate, while the second substrate is in the form of a color filter substrate, and
wherein the plurality of first protrusions and the plurality of second protrusions are both arranged on a black bottom layer of the color filter substrate, and correspond to a plurality of scan lines of the array substrate.

16. The liquid crystal display device according to claim 2, wherein the first substrate is in the form of an array substrate, while the second substrate is in the form of a color filter substrate, and
wherein the plurality of first protrusions and the plurality of second protrusions are both arranged on a black bottom layer of the color filter substrate, and correspond to a plurality of scan lines of the array substrate.

17. The liquid crystal display device according to claim 3, wherein the first substrate is in the form of an array substrate, while the second substrate is in the form of a color filter substrate, and
wherein the plurality of first protrusions and the plurality of second protrusions are both arranged on a black bottom layer of the color filter substrate, and correspond to a plurality of scan lines of the array substrate.

18. The liquid crystal display device according to claim 1, wherein the elastic material is a hydrocarbon polymer, and/or
wherein the rigid material is silicon dioxide or a metal material.

19. The liquid crystal display device according to claim 1, wherein the first upper portion covers the first lower portion, and/or
wherein the second upper portion covers the second lower portion.

20. The liquid crystal display device according to claim 1, wherein the first upper portion and the first lower portion are both configured in the form of truncated cones or truncated ellipsoids, and/or
wherein the second upper portion and the second lower portion are both configured in the form of truncated cones or truncated ellipsoids.
